(19) United States
(12) Patent Application Publication
(10) Pub. No.: US 2007/0004432 A1
(43) Pub. Date: Jan. 4, 2007

(54) Location management and message delivery protocol in multi-region mobile agent computing environment

(76) Inventors: Chong-Sun Hwang, Seoul (KR); Maeng-Soon Baik, Seoul (KR); Sung-Jin Choi, Gunpo-si (KR); Eun Joung Byun, Seoul (KR); Hong Soo Kim, Seoul (KR)

Correspondence Address: FISH & RICHARDSON P.C., P.O. BOX 1022, MINNEAPOLIS, MN, 55440-1022, US

(21) Appl. No.: 11/168,992

(22) Filed: Jun. 29, 2005

(51) Int. Cl. H04Q 7/20

(52) U.S. Cl. 455/461; 455/456.1

(57) ABSTRACT

Disclosed herein is a HB (Home-Blackboard) protocol which is a hybrid protocol of a HP (Home-Proxy) and a Blackboard in multi-region mobile agent computing environment. The present invention provides the HB protocol which is capable of decreasing the cost of location management and message delivery, solving a following problem with low communication cost, and dealing with the location management and message delivery of cloned mobile agents and parent and child mobile agents in a centralized approach and distributed approach, thereby guaranteeing message delivery of these mobile agents.

### BACKGROUND OF THE INVENTION

1. Field of the Invention

The present invention relates to location management and message delivery protocol in multi-region mobile agent computing environment. More particularly, the present invention relates to HB (Home-Blackboard) protocol which is a hybrid protocol of a HP (Home-Proxy) and a Blackboard, capable of decreasing the cost of location management and message delivery, solving a following problem with low communication cost, and dealing with the location management and message delivery of cloned mobile agents and parent & child mobile agents in a centralized approach and distributed approach, thereby guaranteeing message delivery of these mobile agents.

2. Description of the Prior Art

A mobile agent is a program that performs some tasks autonomously on behalf of a user while moving from one node to another. Location management and message delivery protocols are fundamental to the further development of mobile agent systems in a multi-region mobile agent computing environment. It ensures that the mobile agent system controls mobile agents and guarantees message delivery between them.

Several location management and message delivery protocols have been proposed in a mobile agent computing environment, such as Home-Proxy (HP), Forwarding-Proxy (FP), Blackboard, Shadow and SPC (Search-by-Path-Chase) protocol.

In the HP protocol, the location information of mobile agents is stored at a home node or a specific server upon every migration. A home node (HN) is a node which creates the mobile agents. The location information is used to find mobile agents and deliver messages. This protocol has some drawbacks because a HN or a specific server maintains the location information in a centralized way. If a mobile agent moves far away from a HN or a specific server, the cost of location update and message delivery comes to be relatively high. As the number of mobile agents grows and mobile agents migrate frequently, a HN or a specific server can represent a bottleneck. Moreover, if the location information of a HN is not the latest and if a mobile agent already left before a message reached the destination, message delivery is not guaranteed.

In the FP protocol, location information is stored at nodes which a mobile agent has visited. That is, when a mobile agent migrates, a FP is created on each node, which maintains information on the next location of the mobile agent. Locating a mobile agent and delivering a message are achieved by following the chain of proxies that is referred to as path proxies. The FP protocol doesn't involve any updating procedure during migration. However, every node within path proxies must participate in message delivery procedure. If path proxies are long, the cost of message delivery comes to increase. Even though one of path proxies fails, the procedure of message delivery is not achieved. Moreover, if path proxies are long and if a mobile agent already left before a message reached, message delivery is not guaranteed.

In the Blackboard protocol, each node has a blackboard which is a shared information space for message exchange. When any mobile agent wants to deliver a message, it puts the message in the blackboard no matter where receiving mobile agents are or when they read it. Afterward, the receiving mobile agents move to the corresponding node where a message is stored and get the message. In this protocol, every node has storage where messages are deposited. In order to receive a message, mobile agents must move to the corresponding node, which makes unnecessary communication overhead occur. In addition, because the migration pattern of a mobile agent is not regular, message delivery is not performed immediately.

The Shadow protocol is a combination of HP protocol and FP protocol. A mobile agent updates current location to an associated shadow according to TTL (Time To Live). That is, after the TTL, a mobile agent updates its current location, so path proxies come to be cut short. If the TTL still remains, a mobile agent creates an agent proxy that is a kind of forwarding proxy. Thus, the procedure of message delivery is achieved by following the path proxies or through shadow.

The SPC protocol is a combination of HP protocol and FP protocol, applied to a multi-region mobile agent computing environment. Location information is stored in a distributed way at a Region Agent Register (RAR) or a Site Agent Register (SAR). Message delivery is achieved by following a part of the links that the agent has left on two registers.

However, as these protocols are applied to a multi-region mobile agent computing environment, the protocols still have unsettled problems. First, the cost of location management and message delivery is increased relatively. Second, a following problem also arises, which is the problem of tracking nodes that a mobile agent just visited without delivering messages to the mobile agent. Finally, cloned mobile agents and parent and child mobile agents don't get dealt with respect to location management and message delivery.

### SUMMARY OF THE INVENTION

The present invention is conceived to solve the aforementioned problems in the prior art. Accordingly, an object of the present invention is to provide a HB protocol that is a hybrid of a HP protocol and a Blackboard protocol, in order to complement each other and overcome problems of each protocol in multi-region mobile agent computing environment.

Another object of the present invention is to decrease the cost of location management and message delivery, and solve a following problem with low communication cost. In order to solve the high cost of location management and bottleneck problem, each RS administrates location management and message delivery of all mobile agents within its region in contrast to an original HP protocol.

In addition, another object of the present invention is to deal with the location management and message delivery of cloned mobile agents and parent child mobile agents, thereby guaranteeing the message delivery of these mobile agents. Each RS has a blackboard, so that whenever a mobile agent updates its location to its current RS, the RS checks its blackboard. Since a message is stored at a blackboard and the blackboard is checked whenever a mobile agent migrates, this HB protocol guarantees that a message is delivered to a mobile agent.

According to an aspect of the present invention for achieving the objects, the present invention provides a HB protocol in multi-region mobile agent computing environment, comprising a mobile agent which is a program that performs some tasks autonomously on behalf of a user while moving from one node to another; a node which is the execution environment for the mobile agents; a home node (HN) which is the node the mobile agents are firstly created; region server (RS) which is responsible for the authority of its region; a lookup server (LS) which provides a lookup service for mobile agents in region; and wherein each RS has blackboard.

Preferably, the LS contains {AgentID, HNaddr} entries, the RS contains {AgentID, RNaddr, NextRSaddr, Msgs} entries and the HN contains {AgentID, RSaddr} entries, the field AgentID represents the identity or name of a mobile agent, the field HNaddr represents the address of HN which a mobile agent is created first, the field RNaddr represents the address of a resident node (RN) where a mobile agent is to be found, the field NextRSaddr represents the address of the next RS which a mobile agent migrates to, the field Msgs represents messages maintained in the blackboard and the field RSaddr represents the address of the current RS.

According to another aspect of the present invention, there is provided a HB protocol method which is composed of a creation & migration phase (CMP) procedure and a message delivery phase (MDP) procedure, wherein the CMP procedure, comprising steps of: a first step where a mobile agent is created at a HN and sends creation messages to a LS and RS; a second step where, if intra-region migration (Intra-RM) is occurred, the mobile agent sends a location update message to the RS; and a third step where, if inter-region migration (Inter-RM) is occurred, the mobile agent sends location update messages to the HN, a previous RS and a current RS, and wherein the MDP procedure, comprising steps of: a first step where a sender finds the address of a HN by contacting a LS; a second step where sender sends a message to the HN; a third step where the HN finds the address of a current RS and sends the message to the RS; a forth step where, if the message is not emergent, the RS puts the message on its blackboard and in later delivers it to the mobile agent; and a fifth step where, if the message is emergent, the RS investigates the address of RN and sends the message to the mobile agent.

According to a further aspect of the present invention, there is provided a HB protocol method for handling cloned mobile agents (CLMAs) or child mobile agents (CHMAs) in a centralized approach, which is composed of a CMP procedure and a MDP procedure, wherein the CMP procedure, comprising steps of: a first step where, if CLMAs or CHMAs are created, CLMAs or CHMAs send creation messages to LS, RS and HN of their original mobile agent (OCLMA) or parent mobile agent (PMA); a second step where, if Intra-RM is occurred, CLMAs or CHMAs send a location update message to the RS; and a third step where, if Inter-RM is occurred, CLMAs or CHMAs send location update messages to the HN, previous RS and current RS of their OCLMA or PMA, and wherein the MDP procedure, comprising steps of: a first step where sender finds the address of a HN by contacting a LS; a second step where sender sends a message to the HN; a third step where HN finds the address of all RS of CLMAs or CHMAs and sends the message to the RSs; a forth step where, if the message is not emergent, the RSs put the message on its blackboard and in later deliver it to the CLMAs or CHMAs; and a fifth step where, if the message is emergent, the RSs investigate the address of RN of CLMAs or CHMAs and send the message to the CLMAs or CHMAs.

According to a still further aspect of the present invention, there is provided a HB protocol method for handling CLMAs or CHMAs in a distributed approach, which is composed of a CMP procedure and a MDP procedure, wherein the CMP procedure, comprising steps of: a first step where, if CLMAs or CHMAs are created, CLMAs or CHMAs send creation messages to LS, RS and HN of their OCLMA or PMA; a second step where, if Intra-RM is occurred, CLMAs or CHMAs send a location update message to the RS; and a third step where, if Inter-RM is occurred, CLMAs or CHMAs send location update messages to the CN, previous RS and current RS, and wherein the MDP procedure, comprising steps of: a first step where sender finds the address of a CN by contacting a LS; a second step where sender sends a message to the CN; a forth step where CN finds the address of all RSs of CLMAs or CHMAs and sends the message to the RSs; a fifth step where, if the message is not emergent, the RSs put the message on its blackboard and in later deliver it to the CLMAs or CHMAs; and a sixth step where, if the message is emergent, the RSs investigate the address of RN and send the message to the CLMAs or CHMAs.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a schematic view showing a multi-region mobile agent computing environment;

FIG. 2 is a schematic view showing HB protocol in a multi-region mobile agent computing environment according to the present invention;

FIGS. 3a to 3b are flow charts showing a CMP procedure for HB protocol in a multi-region mobile agent computing environment according to the present invention.

FIGS. 4a to 4b are flow charts showing a MDP procedure for HB protocol in a multi-region mobile agent computing environment according to the present invention.

FIG. 5 is the comparison table of the centralized and distributed approach of location management and message delivery for CLMA or CHMA;

FIG. 6 is the graph showing comparison results of the message cost of location management and message delivery protocols; HP, FP, Shadow, SPC and HB protocol;

FIGS. 7a to 7c are the graphs showing the overhead of location management and message delivery; and

FIG. 8 is the graph showing the availability of location management and message delivery.

### DESCRIPTION OF THE PREFERRED EMBODIMENTS

Hereinafter, preferred embodiments of the present invention will be described in detail with reference to the accompanying drawings.

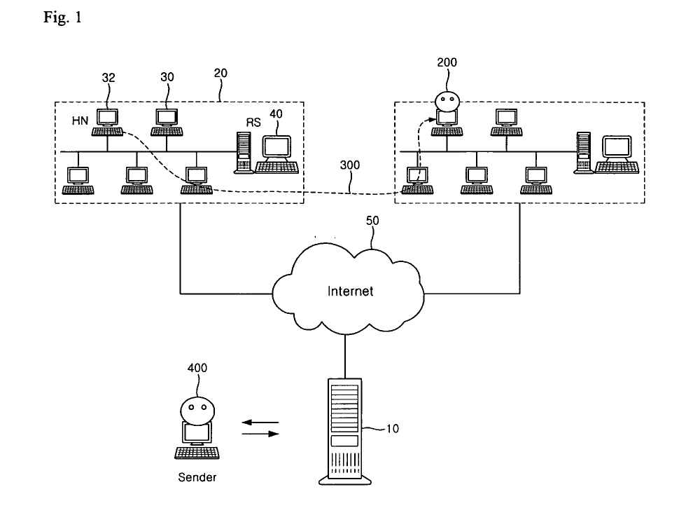

In FIG. 1, a multi-region mobile agent computing environment 100 according to the present invention is illustrated.

Referring to FIG. 1, a multi-region mobile agent computing environment 100 according to the present invention is composed of lookup server (LS) 10 and lots of regions 20. A LS provides a lookup service and a global naming service for mobile agents in region 20. A region 20 is a set of nodes that have the same authority and connected to the LS 10 on Internet 50. In each region 20, there is a region server (RS) 40, which is responsible for the authority of its region, and a few nodes 30 that is execution environment for mobile agents. Specially, the node the mobile agents are firstly created is called home node (HN) 32.

A mobile agent 200 migrates from one node to another while performing a task autonomously on behalf of a user. When a mobile agent 200 migrates, it chooses the next destination according to an itinerary which is a predefined travel plan or dynamically according to execution results. A path from a source (e.g. a HN) to the last destination is called a migration path 300.

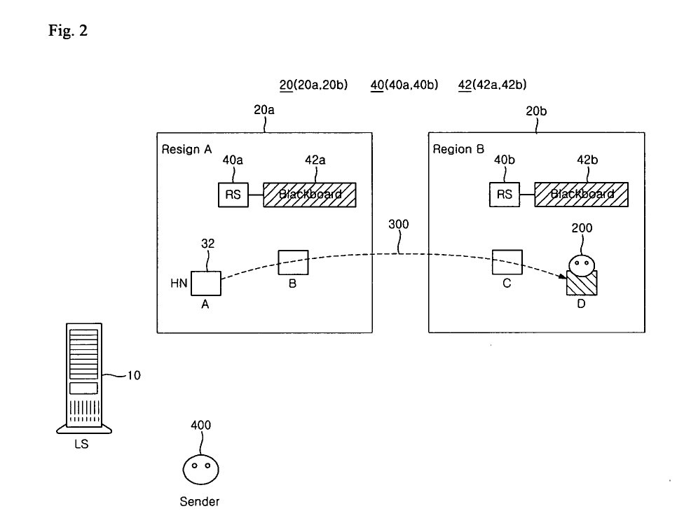

In FIG. 2, a schematic view showing HB protocol in a multi-region mobile agent computing environment according to the present invention is illustrated.

A HB protocol is a hybrid of a HP protocol and a Blackboard protocol in order to complement each other and overcome problems of each protocol. In order to solve the high cost of location management and bottleneck problem, each RS administrates location management and message delivery of all mobile agents within its region in contrast to an original HP protocol.

Referring to FIG. 2, each RS 40 has a blackboard 42. Assume that a mobile agent migrates from a source node A to the last destination node D according to the migration path 300. According to the present invention, whenever the mobile agent 200 updates its location to its current RS 40b, the RS 40b checks its blackboard 42b. If there is a message delivered to a mobile agent 200, the RS 40b delivers them to the mobile agent 200. That is, a mobile agent 200 can receive a message regularly without moving directly to a corresponding node where a message is stored. Placement of a blackboard 42 in a RS 40 solves the following problem. Since a message is stored at a blackboard 42 and the blackboard 42 is checked whenever a mobile agent 200 migrates, this protocol guarantees that a message is delivered to a mobile agent 200.

According to the present invention, a LS 10 contains {AgentID, HNaddr} entries. The field AgentID represents the identity or name of a mobile agent 200 and the HNaddr represents the address of HN (A) 32 which a mobile agent 200 is created first. A RS 40 contains {AgentID, RNaddr, NextRSaddr, Msgs} entries. The field RNaddr represents the address of a resident node (RN)(D) where a mobile agent 200 is to be found, the NextRSaddr represents the address of the next RS 40b which a mobile agent 200 migrates to and the Msgs represents messages maintained in a blackboard 42. A HN (A) 32 contains {AgentID, RSaddr} entries. The field RSaddr represents the address of the RS 40b.

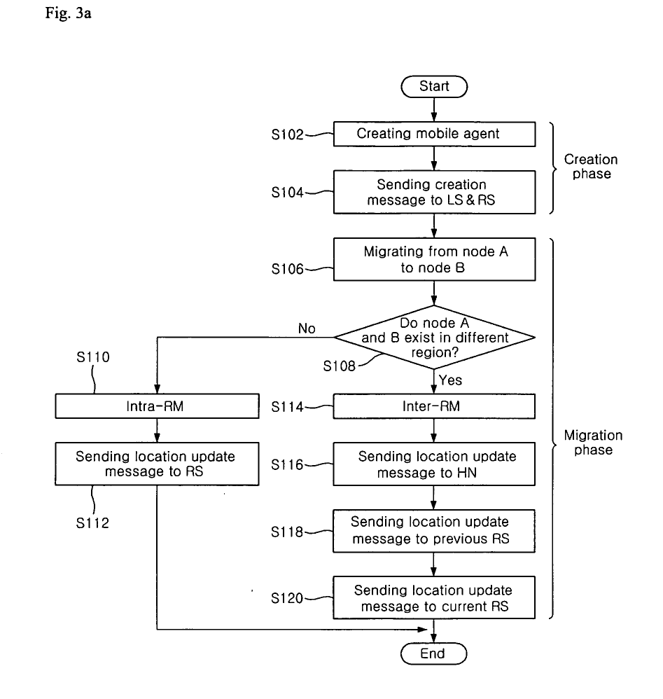

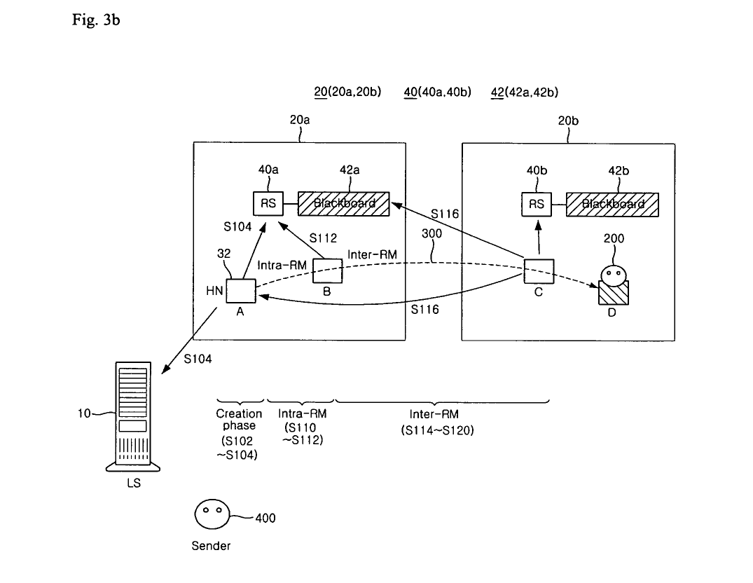

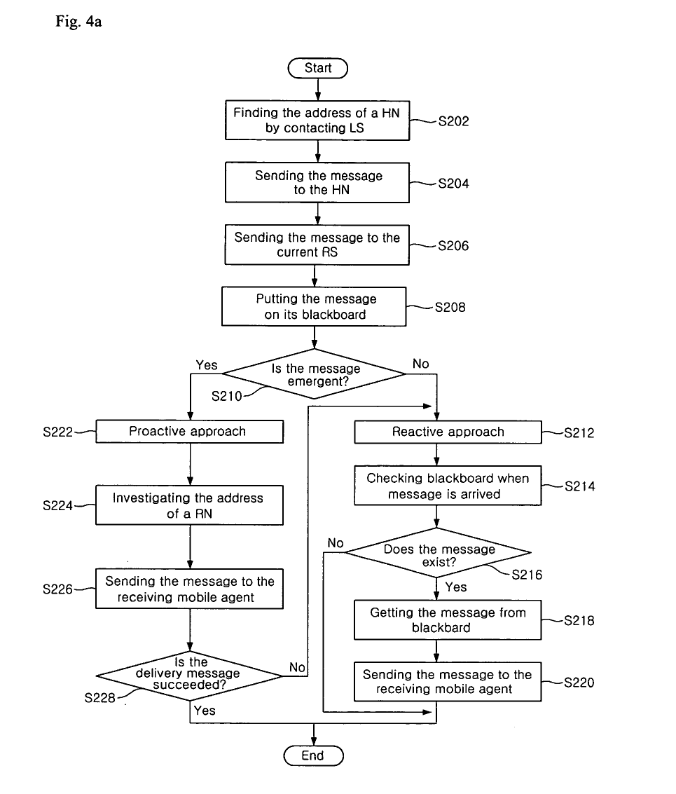

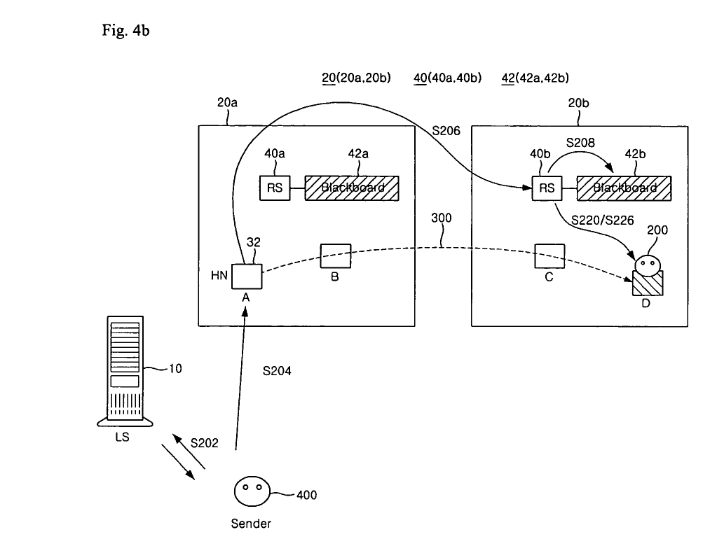

FIG. 3a to 4b are flow charts showing a procedure for HB protocol in a multi-region mobile agent computing environment according to the present invention.

The HB protocol consists of a creation & migration phase (CMP) and a message delivery phase (MDP) procedure. The CMP is a procedure that registers the location of mobile agents to a LS, a HN or a RS. The MDP is a procedure that delivers a message to a mobile agent after finding it.

In FIG. 3a and FIG. 3b, a CMP procedure in a multi-region mobile agent computing environment is illustrated.

Referring to FIG. 3a and FIG. 3b, the CMP according to the present invention is composed of a creation phase (S102˜S104) and a migration phase (S106˜S120). In a creation phase, that is, when a mobile agent 200 is created at a HN 32 (S102), it sends creation messages {AgentID, HNaddr} to a LS 10 and {AgentID, RNaddr} to a RS 40a (S104). Here, RNadder is the same as HNaddr.

If the mobile agent 200 migrates from HN (A) 32 to other node (B) (S106), check whether the next node is in the same region or not (S108). A migration phase is organized into an intra-region migration (antra-RM), the case that a mobile agent migrates within the same region, and an inter-region migration (Inter-RM), the case that a mobile agent migrates within the other region.

If a mobile agent migrates within the same region 20a, in the Intra-RM (S110), a mobile agent 200 sends a location update message {AgentID, RNaddr} only to the RS 40a with which the mobile agent 200 is associated (S112). In an original HP protocol, a mobile agent sends a location update message to a HN or a specific server without respect to its current region. Since a mobile agent sends a location update message irrespective of its current location, the cost of location update is increased. It means that the cost of sending messages within the same region is relatively lower than that of sending messages to a different region.

If a mobile agent 200 migrates within another region 20b, in the Inter-RM (S114), a mobile agent 200 sends location update messages {AgentID, RSaddr} to a HN 32, {AgentID, NextRSaddr} to a previous RS 40a and {AgentID, RNaddr} to a current RS 40b. First, updating a HN 32 guarantees that the HN 32 gets to know a current RS 40b where a mobile agent 200 is located (S116). Second, updating a previous RS 40a guarantees that a mobile agent 200 receives a message which was sent before the current location is not registered in its HN 32 (S118). Finally, a mobile agent 200 sends the location update message to a current RS 40b in order to inform the RS 40b that a mobile agent 200 moves to its region 20b.

In FIG. 4a and FIG. 4b, a flow chart of HB protocol procedure that describes a MDP in a multi-region mobile agent computing environment is illustrated.

Referring to FIG. 4a and FIG. 4b, the MDP according to the present invention has two approaches: reactive and proactive approach. In the reactive approach, message delivery is performed when the RS receives a location update message from a mobile agent. On the other hand, the proactive approach is for emergent delivery. That is, message delivery is performed as soon as the RS receives a message.

To deliver a message, a sender 400 finds the address of a HN 32 by contacting a LS 10 (S202). The sender 400 sends a message to the HN 32 (S204). The HN 32 finds the address of a current RS 40b and sends the message to the RS 40b (S206). The RS 40b puts the message on its blackboard 42b (S208).

If the message is not emergent (S210), that is the reactive approach (S212), the RS 40b checks its blackboard 42b when the RS 40b receives a location update message from a mobile agent 200 (S214). If there is a message for the mobile agent 200 (S216), the RS 40b gets it out from the blackboard 42b (S218), and then delivers it to the receiving mobile agent 200 (S220).

In case of emergent message delivery, the reactive message delivery mechanism has a weakness if a mobile agent 200 has already registered before a message arrived and stays for a long time at a node. That is, message delivery is delayed until the mobile agent 200 migrates to another node. To solve problems, we present a proactive message delivery approach. When a RS 40b receives a message, it immediately sends the message to a RN (D), that is, RNaddr in its list without waiting a location update message. The proactive message delivery approach is as follows.

If the message is emergent (S210), that is the proactive approach (S222), the RS 40b investigates RNaddr for the mobile agent 200 in its entry (S224), and then sends the message to the receiving mobile agent 200 (S226). The proactive approach provides immediate message delivery. However, the proactive approach has a weakness if a mobile agent 200 migrates highly. That is, it requires re-sending the message if message delivery fails (i.e. a mobile agent is under migration), which increases the cost of message delivery. In this case, reactive message delivery is more appropriate than proactive one. In the proactive approach, after sending the message to the mobile agent 200 (S226), if message delivery fails (S228), the reactive message delivery is carried out because the mobile agent 200 is expected to send location update message soon enough.

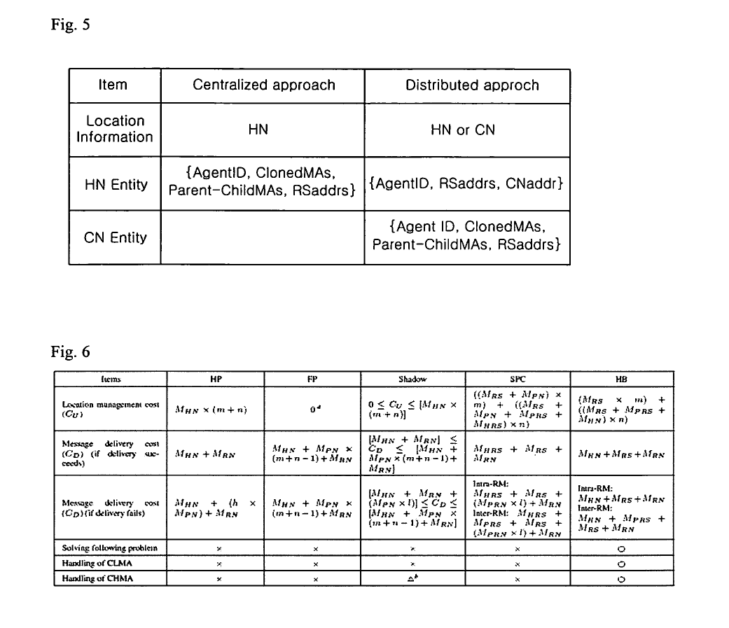

FIG. 5 is the comparison table of the centralized and distributed approach of location management and message delivery for CLMA or CHMA.

The HB protocol, according to the present invention, can deal with the location management and message delivery of cloned mobile agents and parent and child mobile agents.

In the HB protocol, a HN or a creation node (CN) which creates CLMA (CLoned Mobile Agent) or CHMA (CHild Mobile Agent) maintains location information associated to these mobile agents. If a CHMA is created during execution, its location should be recorded in the HN of its PMA (Parent Mobile Agent) or a CN. If the HN of a PMA or a CN doesn't have the information of a CHMA, there is no relationship between the PMA and its CHMA. If a PMA and its CHMA are located in different regions, messages are not delivered to two mobile agents.

For example, if a sender sends a message (e.g. disposal message) to a PMA, this message must be delivered to both the PMA and its CHMA. If this message is delivered only to the PMA, which causes an orphan problem, namely, its CHMA becomes an orphan mobile agent. Therefore, the HN of a PMA should be responsible for the location management and message delivery of its CHMA.

Similarly, if CLMAs are created during execution, the location of CLMAs should be recorded in the HN of an OCLMA (Original CLoned Mobile Agent) or a CN. When CLMAs are located in the same region, the cost of message delivery can be decreased because of sending one message to the same RS.

The approach of location management and message delivery for CLMA or CHMA is categorized into two approaches: centralized and distributed.

Referring to FIG. 5, in a centralized approach according to the present invention, all the location information of CLMAs or CHMAs is maintained in a HN. The HN contains {AgentID, ClonedMAs, Parent-ChildMAs, RSaddrs} entries. The field AgentID represents the identity or name of CLMAs or CHMAs, the field ClonedMAs represents the list of CLMAs, the field Parent-ChildMAs represents the list of PMA and CHMAs and the field RSaddr represents the address of the RS that CLMAs or CHMAs are located.

In the CMP procedure, CLMAs or CHMAs send a creation message {AgentID, HNaddr} to a LS and RS and {AgentID, RSaddr} to a HN when they are first created. The field HNaddr represents the address of HN which OCLMA or PMA is created first.

If Intra-RM is occurred, CLMAs or CHMAs send a location update message {AgentID, RNaddr} to the RS. The field RNaddr represents the address of RN where CLMAs or CHMAs are to be found.

If Inter-RM is occurred, CLMAs or CHMAs send location update messages {AgentID, RSaddr} entries to the HN, {AgentID, NextRSaddr} entries to the previous RS and {AgentID, RNaddr} entries to the current RS. The field NextRSaddr represents the address of the next RS which CLMAs or CHMAs migrate to during inter-RM.

In the MDP procedure, after finding the address of a HN by contacting a LS, sender sends a message to the HN to investigate the address of all RS of CLMAs or CHMAs. After finding the addresses of RSs, the copies of message are delivered to RSs where CLMAs or CHMAs are located. If the message is not emergent, the RSs put the message on its blackboard and in later deliver it to the CLMAs or CHMAs. If the message is emergent, the RSs investigate the address of RN of CLMAs or CHMAs and send the message to the CLMAs or CHMAs.

In a distributed approach according to the present invention, the location information of CLMAs or CHMAs is maintained in a HN or a CN. While a HN maintains the location information of a CN, the HN doesn't maintain that of CLMAs or CHMAs. A CN maintains the location of CLMAs or CHMAs and it sends its location information to a HN. Therefore, a HN contains {AgentID, RSaddr, CNaddr} entries. A CN contains {AgentID, ClonedMAs, Parent-ChildMAs, RSaddrs} entries. The field AgentID represents the identity or name of CLMAs or CHMAs, the field RSaddr represents the address of the RS that CLMAs or CHMAs are located, the field CNaddr represents the address of CN that creates CLMAs or CHMA, the field ClonedMAs represents the list of CLMAs, the field Parent-ChildMAs represents the list of PMA and CHMAs and the field RSaddr represents the address of the RS that CLMAs or CHMAs are located.

In the CMP procedure, CLMAs or CHMAs send a creation message {AgentID, CNaddr} to a LS, RS and HN when they are first created.

If Intra-RM is occurred, CLMAs or CHMAs send a location update message {AgentID, RNaddr} to the RS. The field RNaddr represents the address of RN where CLMAs or CHMAs are to be found.

If Inter-RM is occurred, CLMAs or CHMAs send location update messages {AgentID, RSaddr} entries to the CN, {AgentID, NextRSaddr} entries to the previous RS and {AgentID, RNaddr} entries to the current RS, the field NextRSaddr represents the address of the next RS which CLMAs or CHMAs migrate to during inter-RM.

In the MDP procedure, after finding the address of a CN by contacting a LS, sender sends a message to the CN to investigate the address of all RS of CLMAs or CHMAs. After finding the addresses of RSs, the copies of message are delivered to RSs where CLMAs or CHMAs are located. If the message is not emergent, the RSs put the message on its blackboard and in later deliver it to the CLMAs or CHMAs. If the message is emergent, the RSs investigate the address of RN of CLMAs or CHMAs and send the message to the CLMAs or CHMAs.

FIG. 6 is the graph showing comparison results of the message cost of location management and message delivery protocols; HP, FP, Shadow, SPC and HB protocol when the number of intra-RM is m and the number of inter-RM is n.

In order to assess the message complexity cost, we use the following parameters.

M_{RS}: the cost of a message sent to a current RS where a mobile agent is located

M_{PN}: the cost of a message sent to a previous node (PN) which a mobile agent visited

M_{PRS}: the cost of a message sent to a previous RS

M_{HRS}: the cost of a message sent to a Home RS where a mobile agent is created

M_{HN}: the cost of a message sent to a HN where a mobile agent is created

M_{RN}: the cost of a message sent to a RN where a mobile agent is located

Here, h is the number of nodes that a mobile agent visited due to wrong location information and l is the number of nodes that a mobile agent has traced following path proxies.

As shown in FIG. 6, the location management cost C_{U} of the FP protocol is 0^{a} because the FP protocol doesn't involve any updating procedure during migration. That is, there are no location update messages because location information is maintained in a local forwarding proxy. There is no protocol which is capable of handling with the cloned mobile agents and parent-child mobile agents except HB protocol. The shadow protocol states an orphan problem, but the location management and message delivery is not dealt with.

Thus, the HB protocol is the only that is capable of handling with the cloned mobile agents and parent-child mobile agents, thereby guaranteeing message delivery of these mobile agents. Furthermore, when message delivery fails, in the intra-RM and inter-RM, the message delivery cost CD of the HB protocol is relatively lower than that of the other protocols because the HB protocol solves a following problem. Also, when message delivery succeeds, the message delivery cost of the HP protocol is relatively lower than that of the other protocols because the HB protocol solves a following problem.

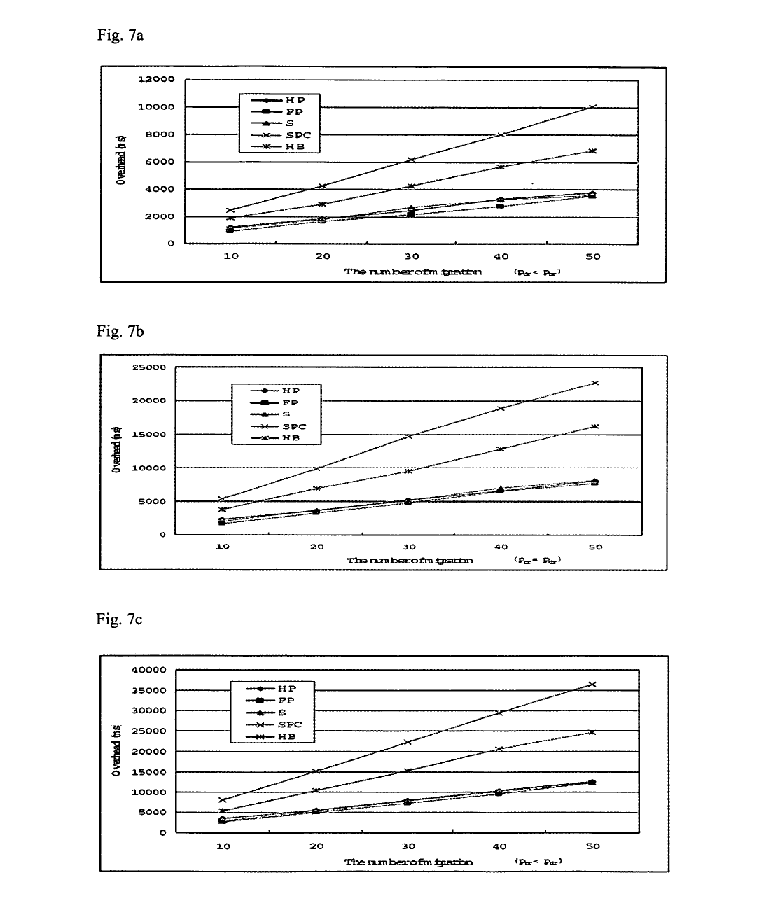

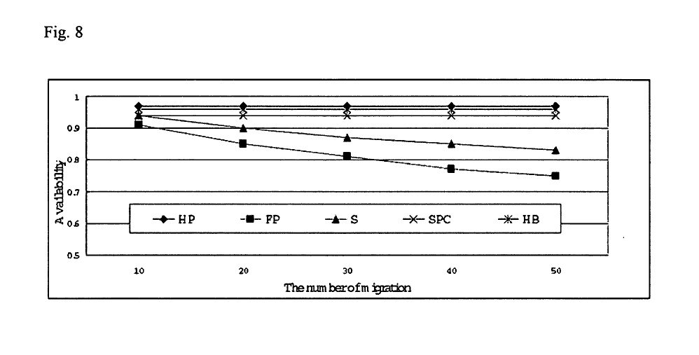

FIG. 7a to FIG. 7c are the graph showing an overhead and FIG. 8 is the graph showing an availability of location management and message delivery.

In order to evaluate location management and message delivery protocols for mobile agents, the following parameters, a location management overhead O_{U}, a message delivery overhead O_{D} and an Availability α are considered.

Total message complexity cost C of location management and message delivery protocol is divided into the location management cost C_{U} and the message delivery cost C_{D}. Assume that the length of a migration path is i, the probability of intra-RM is pₛᵣ, the probability of inter-RM is p_{dr} and the probability that a mobile agent migrates within a home region is pₕ. A home region is a region with which a HN is associated. Here, Pₕ≦pₛᵣ,pₛᵣ₊ₚ_{dr}=1. The cost of location management C_{U} in each protocol is expressed as Equation 1. Here, S represents a Shadow protocol.
C_{U}^{HP}={M_{lHN}×(pₕ×i)}+{M_{rHN}×(1−pₕ)}
C_{U}^{FP}=0
C_{U}^{S}=0 to {M_{lHN}×(pₕ×i)}+{M_{rHN}×(1−pₕ)×i)}
C_{U}^{SPC}={(M_{lRS}+M_{lPN})×(pₛᵣ×i)}+{(M_{lRS}+M_{rPN}+M_{rPRS}+M_{rHRS})×(p_{dr}×i)}
C_{U}^{HB}={M_{lRS}×(pₛᵣ×i)}+{(M_{lRS}+M_{rPRS}M_{rHN})(p_{dr}×i)} [Equation 1]

Here, l denotes sending a message within the same region and r denotes sending a message to a different region. For example, M_{lPN} means sending a message to a previous node within the same region, M_{rPN} means sending a message to a previous node in a different region. Assume that a sender which intents to send a message to a mobile agent is located in a different region from a home region. The cost of message delivery C_{D} is expressed as Equation 2.
C_{D}^{HP}=M_{rHN}+(M_{lRN}×pₕ)+{M_{rRN}×(1×pₕ)}
C_{D}^{FP}=M_{rHN}+[M_{lPN}×{pₛᵣ×(i−1)}]+[M_{rPN}×{p_{dr}×(i−1)}]+{(M_{lRN}×pₛᵣ)+(M_{rRN}×p_{dr})}
C_{D}^{S}=M_{rHN}+(M_{lRN}×pₕ)+{M_{rRN}×(1−pₕ)} to M_{rHN}+[M_{lPN}×{pₛᵣ×(i−1)}]+[M_{rPN}×{p_{dr}×(i−1)}]+{(M_{lRN}×pₛᵣ)+(M_{rRN}×p_{dr})}
C_{D}^{SPC}=M_{lHRS}+(M_{rRS}×p_{dr})+M_{lRN}
C_{D}^{HB}=M_{lHN}+(M_{lRS}×pₛᵣ)+(M_{rRS}×p_{dr})+M_{lRN} [Equation 2]

Also, the location management overhead O_{U}, which is the overhead occurred when a mobile agent migrates from one node to another, and the message delivery overhead O_{D}, which is the overhead occurred when a message is delivered to a mobile agent are calculated as Equation 3.
O_{U}=C_{U}×δ
O_{D}=C_{D}×δ [Equation 3]

Here δ denotes network delay. In order to evaluate each protocol, assume that LAN with bandwidth of 10˜1000 Mbps has latency of 1˜10 ms, WAN with bandwidth of 0.010˜600 Mbps or Internet with bandwidth of 0.010˜2 Mbps has latency of 100˜500 ms. In such a environment, there are three scenarios, that is, the first case is that the probability of intra-RM is higher than that of inter-RM (p_{dr}<pₛᵣ), as shown in FIG. 7a, the second case is that the probability of both is same (p_{dr}=pₛᵣ), as shown in FIG. 7b, the last case is that the probability of intra-RM is lower than that of inter-RM (pₛᵣ<p_{dr}), as shown in FIG. 7c.

Referring FIG. 7a to FIG. 7c, the overhead of location management and message delivery in the case of FIG. 7a is lower than that in the case of FIG. 7c. That is, the higher the probability of inter-RM is, the higher the overhead becomes. The overhead of the SPC protocol and the HB protocol applied to a multi-region mobile agent computing environment is relatively higher than that of the other protocols. However, in comparison with the SPC protocol, the overhead of the HB protocol is lower. Accordingly, it can be understood that, in the multi-region mobile agent computing environment, the HB protocol according to the present invention has excellent performance in comparison to the conventional protocol.

The Availability α is the probability that a system will be operational correctly and be able to deliver the requested services at any given moment. The availability can be written as Equation 4.

$$α = \frac{MTTF}{MTTF + MTTR} \\ where \\ MTTF = \frac{1}{λ} \qquad [ Equation 4 ]$$

Here, MTTF means “mean time to fail” and MTTR means “mean time to repair”. The parameter λ denotes called failure rate. λₙ denotes the failure rate of a node and λ_{c} denotes the failure rate of a channel between nodes. Availability α is classified into location management availability α_{U} and message delivery availability α_{D}. The α_{U} is availability when a mobile agent migrates from one node to another. The α_{D} is availability when a message is delivered to a mobile agent.

When assuming the length of migration path is i, λₙ and λ_{c} are 0.02/hour and MTTR is 0.5 hour, the availability of location management and message delivery is expressed as Equation 5.

$$\begin{matrix}\cdot {α}_{U}^{HP} = \frac{\frac{1}{{λ}_{n} + {λ}_{c}}}{\frac{1}{{λ}_{n} + {λ}_{c}} + 0.5} = \frac{1}{1 + 0.5 ( {λ}_{n} + {λ}_{c} )} \\ \cdot {α}_{U}^{FP} = \frac{\frac{1}{{λ}_{n}}}{\frac{1}{{λ}_{n}} + 0.5} = \frac{1}{1 + 0.5 {λ}_{n}} \\ \cdot {α}_{U}^{S} = \frac{1}{i} {\sum }_{k = 1}^{i} \{ \frac{1}{1 + 0.5 {λ}_{n}} ( i - ⌊ \frac{i}{k} ⌋ ) + \frac{1}{1 + 0.5 ( {λ}_{n} + {λ}_{c} )} ⌊ \frac{i}{k} ⌋ \} \\ \cdot {α}_{U}^{SPC} = \frac{{p}_{sr} \frac{1}{2 {λ}_{n} + 2 {λ}_{c}} + {p}_{dr} \frac{1}{4 {λ}_{n} + 4 {λ}_{c}}}{{p}_{sr} \frac{1}{2 {λ}_{n} + 2 {λ}_{c}} + {p}_{dr} \frac{1}{4 {λ}_{n} + 4 {λ}_{c} + 0.5}} = \frac{{p}_{sr} + 1}{{p}_{sr} + 1 + 2 ( {λ}_{n} + {λ}_{c} )} \\ \cdot {α}_{U}^{HB} = \frac{{p}_{sr} \frac{1}{{λ}_{n} + {λ}_{c}} + {p}_{dr} \frac{1}{3 {λ}_{n} + 3 {λ}_{c}}}{{p}_{sr} \frac{1}{{λ}_{n} + {λ}_{c}} + {p}_{dr} \frac{1}{3 {λ}_{n} + 3 {λ}_{c} + 0.5}} = \frac{2 {p}_{sr} + 1}{2 {p}_{sr} + 1 + 1.5 ( {λ}_{n} + {λ}_{c} )} \\ \cdot {α}_{D}^{HP} = \frac{\frac{1}{2 {λ}_{n} + 2 {λ}_{c}}}{\frac{1}{2 {λ}_{n} + 2 {λ}_{c}} + 0.5} = \frac{1}{1 + {λ}_{n} + {λ}_{c}} \\ \cdot {α}_{D}^{FP} = \frac{\frac{1}{( i + 1 ) i {λ}_{n} + ( i + 1 ) {λ}_{c}}}{\frac{1}{( i + 1 ) {λ}_{n} + ( i + 1 ) {λ}_{c}} + 0.5} = \frac{1}{1 + 0.5 \{ ( i + 1 ) ( {λ}_{n} + {λ}_{c} ) \}} \\ \cdot {α}_{D}^{S} = \frac{1}{1 + {λ}_{n} + {λ}_{c}} or \frac{ 1}{i} {\sum }_{k = 1}^{i} \frac{1}{1 + 0.5 \{ ( k + 1 ) ( {λ}_{n} + {λ}_{c} ) \}} \\ \cdot {α}_{D}^{SPC} = \frac{\frac{1}{3 {λ}_{n} + 3 {λ}_{c}}}{\frac{1}{3 {λ}_{n} 3 {λ}_{c}} + 0.5} = \frac{1}{1 + 1.5 ( {λ}_{n} + {λ}_{c} )} \\ \cdot {α}_{D}^{HB} = \frac{\frac{1}{3 {λ}_{n} + 3 {λ}_{c}}}{\frac{1}{3 {λ}_{n} + 3 {λ}_{c}} + 0.5} = \frac{1}{1 + 1.5} ( {λ}_{n} + {λ}_{c} )\end{matrix} \qquad [ Equation 5 ]$$

In FIG. 8, the availability of the HP, FP, Shadow, SPC and HB protocol is illustrated. As shown in FIG. 8, the availability of HP protocol is higher than that of any other protocols because the location information of mobile agent is stored at a HN or a specific server upon every migration. However, the HP protocol has a drawback because the cost of location update and message delivery comes to be relatively high as mobile agent moves far away from a HN or a specific server.

The availability of HB protocol, according to the present invention, is lower than that of HP protocol. However, it is relatively higher than that of any other protocols. Thus, HB protocol has excellent performance in comparison to the conventional protocol in the multi-region mobile agent computing environment.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

What is claimed is:

1. A HB (Home-Blackboard) protocol in multi-region mobile agent computing environment, comprising:
a mobile agent which is a program that performs some tasks autonomously on behalf of a user while moving from one node to another;
a node which is the execution environment for the mobile agents;
a home node (HN) which is the node the mobile agents are firstly created;
region server (RS) which is responsible for the authority of its region;
a lookup server (LS) which provides a lookup service for mobile agents in region; and
wherein each RS has blackboard.

2. The HB protocol according to claim 1, wherein the LS contains {AgentID, HNaddr} entries, the field AgentID represents the identity or name of a mobile agent and the field HNaddr represents the address of HN which a mobile agent is created first.

3. The HB protocol according to claim 1, wherein the RS contains {AgentID, RNaddr, NextRSaddr, Msgs} entries, the field AgentID represents the identity or name of a mobile agent, the field RNaddr represents the address of a resident node (RN) where a mobile agent is to be found, the field NextRSaddr represents the address of the next RS which a mobile agent migrates to and the field Msgs represents messages maintained in the blackboard.

4. The HB protocol according to claim 1, wherein the HN contains {AgentID, RSaddr} entries, the field AgentID represents the identity or name of a mobile agent and the field RSaddr represents the address of the current RS.

5. A HB protocol method which is composed of a creation & migration phase (CMP) procedure and a message delivery phase (MDP) procedure,
wherein the CMP procedure, comprising steps of:
a first step where a mobile agent is created at a HN and sends creation messages to a LS and RS;
a second step where, if intra-region migration (Intra-RM) is occurred, the mobile agent sends a location update message to the RS; and
a third step where, if inter-region migration (Inter-RM) is occurred, the mobile agent sends location update messages to the HN, a previous RS and a current RS,
and wherein the MDP procedure, comprising steps of:
a first step where a sender finds the address of a HN by contacting a LS;
a second step where sender sends a message to the HN;
a third step where the HN finds the address of a current RS and sends the message to the RS;
a forth step where, if the message is not emergent, the RS puts the message on its blackboard and in later delivers it to the mobile agent; and
a fifth step where, if the message is emergent, the RS investigates the address of RN and sends the message to the mobile agent.

6. The HB protocol method according to claim 5, wherein, in the first step of the CMP procedure, the mobile agent sends creation messages composed of {AgentID, HNaddr} entries to the LS and {AgentID, RNaddr} entries to RS, the field AgentID represents the identity or name of a mobile agent, the field HNaddr represents the address of HN which a mobile agent is created first and the field RNaddr represents the address of a RN where a mobile agent is to be found.

7. The HB protocol method according to claim 6, wherein the RNaddr is the same as HNaddr.

8. The HB protocol method according to claim 5, wherein, in the second step of the CMP procedure, the mobile agent sends location update messages composed of {AgentID, RNaddr} entries to RS, the field AgentID represents the identity or name of a mobile agent and the field RNaddr represents the address of RN where a mobile agent is to be found.

9. The HB protocol method according to claim 5, wherein, in the third step of the CMP procedure, wherein the mobile agent sends location update messages composed of {AgentID, RSaddr} entries to the HN, {AgentID, NextRSaddr} entries to the previous RS, {AgentID, RNaddr} entries to the current RS, the field AgentID represents the identity or name of a mobile agent, the field RSaddr represents the address of the current RS, the field NextRSaddr represents the address of the next RS which a mobile agent migrates to during inter-RM and the field RNaddr represents the address of RN where a mobile agent is to be found.

10. The HB protocol method according to claim 5, wherein the forth step of the MDP procedure includes
a step of putting the message on its blackboard;
a step of checking the blackboard when receiving a location update message from a mobile agent; and
a step of, if there is a message, getting it from the blackboard and delivering it to the mobile agent.

11. The HB protocol method according to claim 5, if message delivery fails in the fifth step of the MDP procedure, further comprising a sixth step of putting the message on a blackboard and in later delivers it to the mobile agent.

12. A HB protocol method for handling cloned mobile agents (CLMAs) or child mobile agents (CHMAs) in a centralized approach, which is composed of a CMP procedure and a MDP procedure,
wherein the CMP procedure, comprising steps of:
a first step where, if CLMAs or CHMAs are created, CLMAs or CHMAs send creation messages to LS, RS and HN of their original mobile agent (OCLMA) or parent mobile agent (PMA);
a second step where, if Intra-RM is occurred, CLMAs or CHMAs send a location update message to the RS; and
a third step where, if Inter-RM is occurred, CLMAs or CHMAs send location update messages to the HN, previous RS and current RS of their OCLMA or PMA,
and wherein the MDP procedure, comprising steps of:
a first step where sender finds the address of a HN by contacting a LS;
a second step where sender sends a message to the HN;
a third step where HN finds the address of all RS of CLMAs or CHMAs and sends the message to the RSs;
a forth step where, if the message is not emergent, the RSs put the message on its blackboard and in later deliver it to the CLMAs or CHMAs; and
a fifth step where, if the message is emergent, the RSs investigate the address of RN of CLMAs or CHMAs and send the message to the CLMAs or CHMAs.

13. The HB protocol method for handling CLMAs or CHMAs in a centralized approach according to claim 12, wherein, in the first step of the CMP procedure, CLMAs or CHMAs send creation messages composed of {AgentID, HNaddr} entries to the LS and RS, {AgentID, RSaddrs} entries to a HN, the field AgentID represents the identity or name of CLMAs or CHMAs, the field HNaddr represents the address of HN which OCLMA or PMA is created first and the field RSaddr represents the address of the RS that CLMAs or CHMAs are located.

14. The HB protocol method for handling CLMAs or CHMAs in a centralized approach according to claim 12, wherein, in the second step of the CMP procedure, CLMAs or CHMAs send a location update message composed of {AgentID, RNaddr} entries to RS, the field AgentID represents the identity or name of CLMAs or CHMAs, and the field RNaddr represents the address of RN where CLMAs or CHMAs are to be found.

15. The HB protocol method for handling CLMAs or CHMAs in a centralized approach according to claim 12, wherein, in the third step of the CMP procedure, wherein CLMAs or CHMAs send location update messages composed of {AgentID, RSaddr} entries to the HN, {AgentID, NextRSaddr} entries to the previous RS, {AgentID, RNaddr} entries to the current RS, the field AgentID represents the identity or name of CLMAs or CHMAs, the field RSaddr represents the address of the RS that CLMAs or CHMAs are located, the field NextRSaddr represents the address of the next RS which CLMAs or CHMAs migrate to during inter-RM and the field RNaddr represents the address of RN where CLMAs or CHMAs are to be found.

16. The HB protocol method for handling CLMAs or CHMAs in a centralized approach according to claim 12, wherein the forth step of the MDP procedure includes
a step of putting the message on its blackboard;
a step of checking the blackboard when receiving a location update message from the CLMAs or CHMAs; and
a step of, if there is a message, getting it from the blackboard and delivering it to the CLMAs or CHMAs.

17. The HB protocol method for handling CLMAs or CHMAs in a centralized approach according to claim 12, if message delivery fails in the fifth step of the MDP procedure, further comprising a sixth step of putting the message on a blackboard and in later delivers it to the CLMAs or CHMAs.

18. A HB protocol method for handling CLMAs or CHMAs in a distributed approach, which is composed of a CMP procedure and a MDP procedure, wherein the CMP procedure, comprising steps of:
a first step where, if CLMAs or CHMAs are created, CLMAs or CHMAs send creation messages to LS, RS and HN of their OCLMA or PMA;
a second step where, if Intra-RM is occurred, CLMAs or CHMAs send a location update message to the RS; and
a third step where, if Inter-RM is occurred, CLMAs or CHMAs send location update messages to the CN, previous RS and current RS,
and wherein the MDP procedure, comprising steps of:
a first step where sender finds the address of a CN by contacting a LS;
a second step where sender sends a message to the CN;
a forth step where CN finds the address of all RSs of CLMAs or CHMAs and sends the message to the RSs;
a fifth step where, if the message is not emergent, the RSs put the message on its blackboard and in later deliver it to the CLMAs or CHMAs; and
a sixth step where, if the message is emergent, the RSs investigate the address of RN and send the message to the CLMAs or CHMAs.

19. The HB protocol method for handling CLMAs or CHMAs in a distributed approach according to claim 18, wherein, in the first step of the CMP procedure, CLMAs or CHMAs send creation messages composed of {AgentID, CNaddr} entries to the LS, RS and HN, the field AgentID represents the identity or name of CLMAs or CHMAs and the field CNaddr represents the address of CN which CLMAs or CHMAs are created first.

20. The HB protocol method for handling CLMAs or CHMAs in a distributed approach according to claim 18, wherein, in the second step of the CMP procedure, CLMAs or CHMAs send a location update message composed of {AgentID, RNaddr} entries to RS, the field AgentID represents the identity or name of CLMAs or CHMAs and the field The field RNaddr represents the address of RN where CLMAs or CHMAs are to be found.

21. The HB protocol method for handling CLMAs or CHMAs in a distributed approach according to claim 18, wherein, in the third step of the CMP procedure, wherein CLMAs or CHMAs send location update messages composed of {AgentID, RSaddr} entries to the CN, {AgentID, NextRSaddr} entries to the previous RS, {AgentID, RNaddr} entries to the current RS, the field AgentID represents the identity or name of CLMAs or CHMAs, the field RSaddr represents the address of the RS that CLMAs or CHMAs are located, the field NextRSaddr represents the address of the next RS which CLMAs or CHMAs migrate to during inter-RM and The field RNaddr represents the address of RN where CLMAs or CHMAs are to be found.

22. The HB protocol method for handling CLMAs or CHMAs in a distributed approach according to claim 18, wherein the fifth step of the MDP procedure includes
a step of putting the message on its blackboard;
a step of checking the blackboard when receiving a location update message from the CLMAs or CHMAs; and
a step of, if there is a message, getting it from the blackboard and delivering it to the CLMAs or CHMAs.

23. The HB protocol method for handling CLMAs or CHMAs in a distributed approach according to claim 18, if message delivery fails in the sixth step of the MDP procedure, further comprising a sixth step of putting the message on a blackboard and in later delivers it to the CLMAs or CHMAs.
